(19) United States
(12) Patent Application Publication
(10) Pub. No.: US 2019/0024628 A1
(43) Pub. Date: Jan. 24, 2019

(54) WIND TURBINE BLADE, TUBULAR STRUCTURE FOR WIND TURBINE BLADE, WIND TURBINE AND WIND-UTILIZATION MONITORING METHOD

(71) Applicants: Rodrigo Perazzo Azevedo Dantas, Recife (BR); Marcelo Monteiro DE BARROS, Rio Clara (BR)

(72) Inventor: Marcelo Monteiro De Barros, Rio Clara (BR)

(21) Appl. No.: 15/763,097

(22) PCT Filed: Sep. 26, 2016
(86) PCT No.: PCT/BR2016/050237

§ 371 Date: Aug. 20, 2018

(30) Foreign Application Priority Data
Sep. 24, 2015 (BR) BR 102015024612-9

(51) Int. Cl. F03D 1/06; F03D 7/02

(52) U.S. Cl. CPC F03D 1/0675; F03D 1/0633; F03D 7/0224; F05B 2280/2006; F05B 2240/2211; F05B 2240/302; F05B 2250/02; F03D 7/0232

(57) ABSTRACT

The present invention describes a wind turbine whose blades have: a differentiated slope intended to compensate for the structural deformations caused by the wind action; a pitch control mechanism for better use of wind speed and direction in each section of blade length; parallel internal and movable structural tubes with each other that make the blade structure more flexible; steel wires connecting the blade ends so that they remain cable-stayed and rigid against wind forces; besides a tubular structure for wind blade; a wind turbine; and a method of controlling wind utilization. The present invention is in the field of renewable energy technologies.

### FIELD OF THE INVENTION

The present invention describes a wind blade having a differentiated slope, modular pitch control mechanism, internal structural tubes parallel and movable with each other, and steel wires connecting the ends of different blades, in addition to a tubular structure for wind blade, a wind turbine and a method of controlling wind utilization. The present invention is in the field of renewable energy technologies.

### BACKGROUND OF THE INVENTION

The mechanisms of obtaining energy from the wind, more widely known as wind turbines, have been studied and developed in large scale by companies of the sectors of technology and renewable energy in Brazil and around the world. Due to the current growing ecological awareness, the increasing importance of using the natural air flow as an energy source makes it essential to add improvements in the wind turbine system, mainly aiming at higher performance during the operation of these machines.

Currently, each of the major wind turbines mostly used around the world produces about 1.67 MWh of electricity. The wind turbine is the device inside the housing at the top of the turbine, and it is responsible for the changing wind energy into electrical power and is basically constituted by an electricity generator connected to wind turbines. The height of the structure supporting the wind turbine is approximately 100 meters, as well as the diameter of the rotor (understood as the component comprising the blades), and it can vary according to the turbine generating capacity.

The blades rotation intensity, that is to say, of the rotor, is due to the speed and the direction of incidence of the wind. The relationship between the length and the contact area of the blades with the external environment is not linear, which means that a small increase in blade length represents a huge increase in the contact area with the environment. Thus, for wind turbines located in regions with lower wind incidence, it is interesting to use wind blades longer than average.

Generally, when the wind speed value is above a certain threshold, the blades are adjusted in order to terminate system operation to prevent damage. The mechanical energy acquired by the rotor axis, as a function of its rotation, is transferred to the three-phase induction generator capable of converting it into electrical energy in three-phase form.

The effective average value of the induced electrical voltage is 690 V. At the base of the turbine, the transmission lines conduct the electric current generated to a distribution transformer where the voltage is increased to a few thousand Volts (high voltage), allowing the transmission of electricity to more distant stations and subsequently to the consumer centers. It is important to note that as the turbine system performs an electromechanical conversion whose parameters are high, the nacelle (upper casing) of the turbine contains a proportional cooling/ventilation system and only skilled technicians can perform the periodic maintenance of the wind turbine.

Conventional wind turbines have a small slope angle in modulus or zero relative to the plane containing the vertical structure of the turbine, i.e. the long structure connecting the base to the turbine top casing. This is due to the fact that, to compensate for the structural deformation of the blades due to the wind incidence, the current turbines have the nacelle (upper casing) inclined from 15° to the horizontal.

Unfortunately, the mechanisms of wind turbines currently used (mainly at the national level) are unable to fully accommodate the constant changes in wind direction, strength and speed. This is because they still lack a differentiated structure that improves the flexibility and rigidity of these rotor components, and compensates for the structural deformations that the blades suffer from the action of the wind.

In addition, conventional blades have pitch control for best use of wind speed at any instant, however, pitch variation takes into account only the optimization of power generation as a function of the blade length section that has greater efficiency (their ends), without taking into account the other sections of blade length, which could have better performance if they had different angles.

Thus, as can be seen from the literature researched, no documents were found anticipating or suggesting the teachings of the present invention, so that the solution proposed herein has novelty, industrial application and inventive activity against the state of the art.

### SUMMARY OF THE INVENTION

Accordingly, the present invention aims to solve the problems encountered in the prior art from: a novel structural configuration of the interior of the wind turbines which increases the flexibility thereof; a blade end connection mechanism which increases the stiffness of the assembly; a new slope angle (θ) of the blades and the nacelle (1) in order to compensate the deformation due to the action of the wind; and a pitch angle control system of different blade sections.

In accordance with the present invention, in order to improve the flexibility of the wind blades, and less weight, it is necessary that the interior thereof be composed of structural tubes (2) associated in parallel and movable with each other. For improvement of blade rigidity: it is first necessary that they have a slope angle θ, approximately equal to the slope angle β of the nacelle (1) with the ground, which compensates for the structural deformation; and secondly it is necessary to connect the ends of the blades using a resilient cable (4) so that they are stationary. A pitch angle control system is also essential for blades to adapt to variations in wind direction and speed, increasing overall system performance and reducing the risk of damage to the equipment.

These and other objects of the invention will be readily appreciated by those skilled in the art and by companies having interests in the art and will be described in sufficient detail for their reproduction in the following description.

### BRIEF DESCRIPTION OF THE DRAWINGS

The following figures are presented in order to better define and clarify the contents of the present patent application:

FIG. 1 shows an example of the cross-section of an embodiment of the blade, sectioned in three parts (A-B-C), and some of the cylindrical structural tubes (2) comprising it, according to the present invention, tubes (2) run through almost the entire internal length of the blade and have a rubber absorbent material (3) connecting their ends.

FIG. 2a shows a state-of-the-art wind turbine, where the nacelle (1) has a slope angle (β) from 5° to 7° with the horizontal to prevent contact of the blades with the tower (5), when the blades are flexed by the action of the wind.

FIG. 2b shows an embodiment of the wind turbine of the present invention, wherein each blade has an angle (θ) from 5° to 7° with the vertical plane, the nacelle (1) supporting said blades arranged at an angle horizontal (β) parallel to the ground.

FIG. 3 shows an embodiment of the front (at left) and lateral (at right) profiles of a wind turbine in accordance with the present invention in which the ends of the blades are connected by steel wire (4).

FIG. 4 shows an embodiment of an example of a single wind blade according to the present invention, sectioned in three parts (A-B-C) whose pitch angles can be controlled.

FIG. 5 shows an embodiment of the wind blade profile and how the pitch angle of each can vary depending on its mechanical configuration.

### DETAILED DESCRIPTION OF THE INVENTION

The following descriptions are given by way of example and not limiting the scope of the invention and will make the object of the present patent application more clearly understood.

The structural tubes (2) inside of the wind turbines are associated in parallel and are movable with each other. These two characteristics allow the blade to be flexible, which is an essential requirement for the proper work of a wind turbine. Wind constantly changes speed, strength and direction, and the absence of a flexible structure in this equipment can cause extremely damaging or even irreparable mechanical damage.

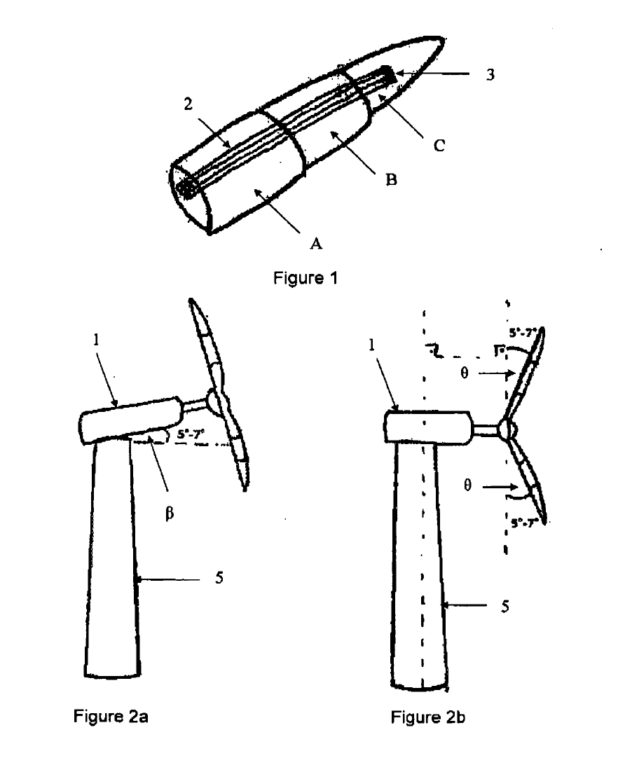

The cross-sectional profile of these tubes (2) may vary from circular to hexagonal, but it is necessary that such profile be standardized, since as the tubes (2) will be in contact, they must be compatible so as not to compromise the safety of the blade. The ends of the tubes (2) are attached by a rubber material (3) responsible for controlling the deformation thereof as they move relative to each other, according to FIG. 1.

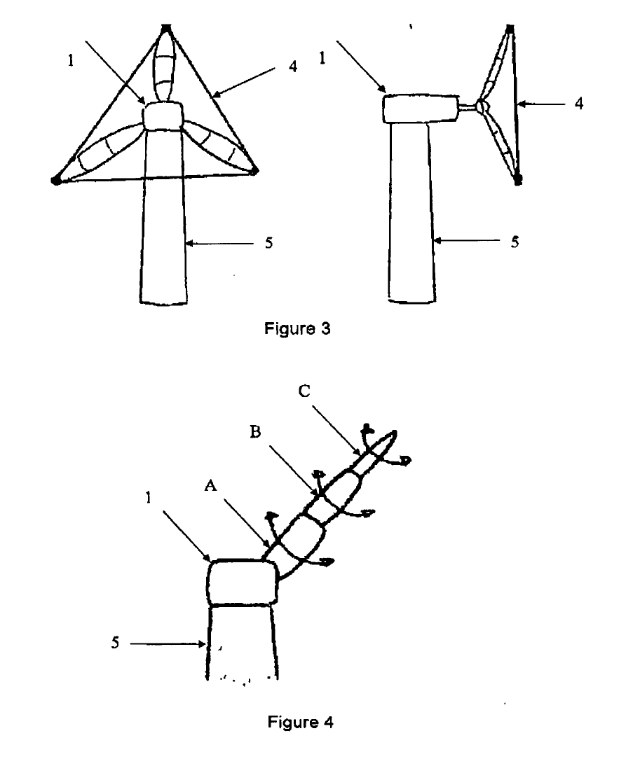

In order to increase the stiffness of the turbine blades, the present invention proposes the use of a steel wire (4) connecting the ends of the blades in order to keep the assembly stable against the action of the wind, as shown by FIG. 3, which increases the performance of the system by the fact that the rotor stores more amount of mechanical energy and also reduces the risk of accidents or damage to the wind structure.

Last but not least, the Active Blade mode referred to herein represents a pitch angle control system of each blade region. Its operation is similar to the operation of the wing flaps mechanism in aircraft for manual control of flight altitude, that is, the wings of an aircraft have flaps whose angles (in relation to the wind incidence plane) vary, causing the gain or loss of high of the vehicle, as shown in FIG. 5.

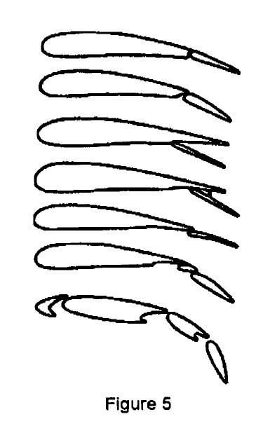

In other words, to increase the efficiency of the system and considering that the physical characteristics of the wind are different for each blade length section, each section will have its pitch angle modified according to its current yield, according to the example of FIG. 4.

### Example 1. Preferred Embodiment

In one embodiment of the present invention, the material used in making the structural tubes (2) of the wind blades is of resistant carbon fiber. The slope angle (θ) of each of the wind blades varies from 5° to 7° in relation to the plane containing the vertical structure of the turbine, so that the blades do not collide with the tower (5) in the case of strong winds or gusts, as the example in FIG. 2b illustrates.

### Example 2. Preferred Embodiment

In a second embodiment of the present invention, the material used in making the structural tubes (2) of the wind blades is of resistant carbon fiber. The slope angle (β) of the nacelle (1) to the horizontal is about 5° to 7°, according to FIG. 2a, and the slope angle (θ) of the wind blades in relation to the vertical plane also has a value close to this, thus preventing strong gusts of wind causing the blades to collide with the tower (5) of the turbine.

### Example 3. Preferred Embodiment

In a third embodiment of the present invention, the material used in making the structural tubes (2) of the wind blades is of resistant carbon fiber. The Active Blade mode can also control the pitch angle of the different wind blade sections by means of a continuous metal filament, constituting the outer structure of the blades, that is: a system consisting of a flexible, resilient and torsion resistant material to the point where it allows twisting of the wind blades without causing structural damage or turbulence therein.

### Example 4. Preferred Embodiment

In a fourth embodiment of the present invention, the material used in making the structural tubes (2) of the wind blades is of resistant carbon fiber. The Active Blade mode can be configured to: perform variable pitch angle control of different wind blade longitudinal sections, as shown in FIG. 4; and/or perform variable pitch angle control along its width, in different mechanical configurations, as in the flap system, exemplified by FIG. 5.

Those skilled in the art will appreciate the knowledge presented herein and may reproduce the invention in the embodiments presented and in other embodiments, falling within the scope of the appended claims.

1. A wind blade, comprising at least one of:
a) an internal composition of at least one structural tube;
b) a differentiated slope angle (θ) with a vertical plane;
c) movable sections for pitch angle adjustment by regions; and
d) at least one end connected to ends of other wind blades by a wire.

2. The wind blade according to claim 1, wherein the at least one end is connected to the ends of the other wind blades by at least one steel wire.

3. The wind blade according to claim 1, wherein the wind blade has a structure that is composed of a flexible, resilient and torsion resistant metal filament.

4. A tubular structure for a wind blade, comprising tube threads defined by the association of a plurality of tubes in parallel along a length of the wind blade.

5. The tubular structure according to claim 4, wherein the tubes are overlapped and movable with each other.

6. The tubular structure according to claim 5, further comprising a material for associated deformation absorption at ends of the tube threads.

7. The tubular structure according to claim 6, wherein the tubes are composed of carbon fiber.

8. A wind turbine, comprising:
a nacelle; and
blades associated with the nacelle,
wherein the blades are inclined at an angle (θ) of 5° to 7° with respect to a vertical plane in a direction distal to the nacelle.

9. A method of controlling wind utilization, comprising a step of changing a pitch angle of at least one section of a wind blade as a function of wind conditions affecting the wind blade and/or by means of inclination of flaps arranged in edges of the wind blade.

10. The wind blade according to claim 2, wherein the wind blade has a structure that is composed of a flexible, resilient and torsion resistant metal filament.
